(19) United States
(12) Patent Application Publication
(10) Pub. No.: US 2013/0061223 A1
(43) Pub. Date: Mar. 7, 2013

(54) SYSTEM AND METHOD FOR CACHING OPTIMIZATION OF GUEST OPERATING SYSTEMS FOR DISRIBUTED HYPERVISOR

(71) Applicants: Michael A. Avina, Tampa, FL (US); Timothy M. Roberts, Tampa, FL (US)

(72) Inventors: Michael A. Avina, Tampa, FL (US); Timothy M. Roberts, Tampa, FL (US)

(73) Assignee: SAVTIRA CORPORATION, INC., Tampa, FL (US)

(21) Appl. No.: 13/402,501

(22) Filed: Feb. 22, 2012

Related U.S. Application Data
(60) Provisional application No. 61/445,065, filed on Feb. 22, 2011.

(51) Int. Cl. G06F 9/455

(52) U.S. Cl. 718/1

(57) ABSTRACT

The disclosed embodiments relate to a method, an apparatus, and computer-readable medium storing computer-readable instructions for optimizing the delivery and/or enablement of guest operating systems to distributed hypervisors.

### RELATED APPLICATION DATA

This application claims priority to U.S. Provisional Application No. 61/445,065, filed Feb. 22, 2011, which is hereby incorporated by reference in its entirety.

### BACKGROUND

Executing an instance of a virtual machine on a server within a distributed environment provides the user with the ability to access applications, media and entertainment using low-cost display devices connected via the Internet. This significantly reduces the investment of the user and provides the flexibility for the user to quickly access a wide array of applications that are operated by servers existing within a distributed or “cloud” server and storage environment.

Existing guest virtual machine (“VM”) systems initiate either the saved state of a particular application or initiate the startup of a VM when the user makes a request to a hypervisor host via the internet. The user is presented with a display indicating that the user should wait until the VM becomes available. Until now this latency between a user requesting access to an application or media and the application or media becoming available to the user is undesirable. The disclosed embodiment seeks to solve this problem in the numerous instances where the content can be predicted using standard statistical algorithms based on demand data.

A hypervisor, also called a virtual machine monitor, is a virtualization technique which provides for the capability to run multiple operating systems (called “guests” or VMs) within a single host. It is conceptually called a hypervisor because it is considered to be one level above the level of supervisor. Hypervisors are installed on server hardware whose only task is to run guest operating systems.

In computer engineering a cache is a type of system that transparently stores data so that future requests can be served faster. Typically, when a user or system administrator initiates a VM session, the VM is loaded when the user makes a request for access to a particular virtual machines configuration. VM configurations typically incorporate a configuration for the operating system, system configuration, network configuration, installed applications and system state. The system state is typically the state of the VM system's memory and active processes at any given time.

### SUMMARY

The disclosed embodiment relates to, for example, a statistical database containing time-based historical, statistical, usage data, a distributed or centralized storage system containing complete template images of guest operating systems, a distributed or centralized storage system containing fragment images of guest operating systems where the fragment is the difference between two guest operating system images, a server running a hypervisor or other type of hardware virtualization environment that allows guest operating systems to execute, a pre-loading process that pre-loads virtual machine images, a process that is able to overwrite the paused image of a virtual machine with fragments of data prior to it being loaded, and software capable of streaming the display of the virtual machine to any connected device.

The time-based data may contain information relating to which VM image a user accessed at any given time. The server may be running any platform capable of virtualizing operating systems or software. Each pre-loaded virtual machine may be initialized and executed in memory prior to any user accessing it. Each pre-loaded virtual machine may be in a paused state prior to being accessed by an external user. The virtual machine may be placed in running mode once a request is made.

In addition, the disclosed embodiment relates to a method of optimizing the delivery and/or enablement of guest operating systems to distributed hypervisors. An exemplary method comprises pre-loading a virtual machine image, overwriting the pre-loaded virtual machine image with fragments of data, and streaming a display of the virtual machine to any connected device.

The disclosed embodiment further relates to an apparatus for optimizing the delivery and/or enablement of guest operating systems to distributed hypervisors. An exemplary apparatus comprises one or more processors, and one or more memories operatively coupled to at least one of the one or more processors and containing instructions that, when executed by at least one of the one or more processors, cause at least one of the one or more processors to pre-load a virtual machine image, overwrite the pre-loaded virtual machine image with fragments of data, and stream a display of the virtual machine to any connected device.

Moreover, the disclosed embodiment relates to at least one non-transitory computer-readable medium storing computer-readable instructions that, when executed by one or more computing devices, optimize the delivery and/or enablement of guest operating systems to distributed hypervisors. Exemplary instructions cause at least one of the one or more computing devices to pre-load a virtual machine image, overwrite the pre-loaded virtual machine image with fragments of data, and stream a display of the virtual machine to any connected device.

### BRIEF DESCRIPTION OF THE DRAWINGS

FIG. 1 illustrates an exemplary embodiment in which a user accesses a VM via a console or computer.

FIG. 2 illustrates an exemplary embodiment.

FIG. 3 refers to an exemplary embodiment where VMs are assembled from fragments of data and template VM images.

FIG. 4 illustrates an exemplary computing device according to the disclosed embodiment.

### DETAILED DESCRIPTION

The disclosed embodiment seeks to reduce the load times for a VM using two techniques. First, predictive analytical techniques can be used to determine how many of a particular type of VM to preload at any given time. Any user making a request for access to a VM is directed to a VM that was preloaded within a server cluster located closest to the user making the request for access to a VM. This eliminates the latency when loading a VM and any network latency between the server running the VM and the user accessing the VM. Second, distributed caching of VM machine data can be used to significantly reduce the time necessary to load a VM. VM machine data is analyzed, parsed, and then distributed between servers. Runnable VMs are assembled and pre-loaded within the hypervisor of a VM. Each runnable VM is given a unique tag which can be used to lookup differential memory data necessary to bring the running VM's program state to a desired set point without the need to execute program code.

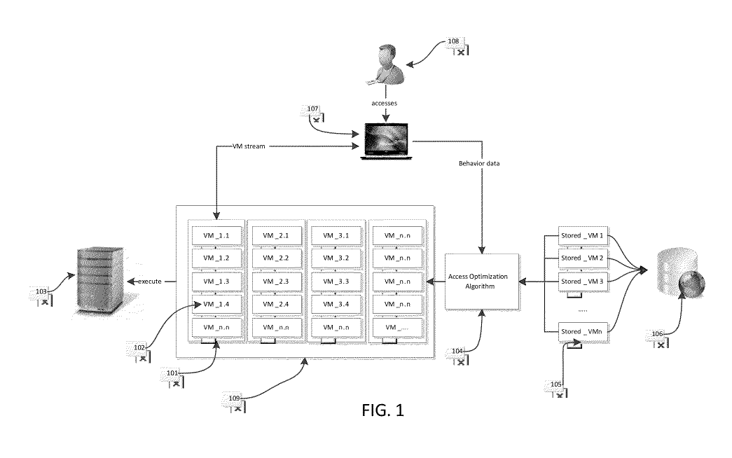

Referring to the diagrams, FIG. 1 represents an embodiment where a user 108, accesses a VM 102 via a console or computer 107. When the user 108 accesses the VM 102, the server 103 executes the VM 102 and provides a display to the user's 108 computer 107. If a VM 102 meeting the user's 108 request is not available, then a stored VM 105 is loaded by the server 103 from a database or file system 106.

The server 103 attempts to predict, using an analytical algorithm 104, how many VMs 102 to load into a cluster 101 by analyzing historical usage data within the database 106. This process ensures that a VM 102 is always available prior to a user 108 making a request for a particular VM 102.

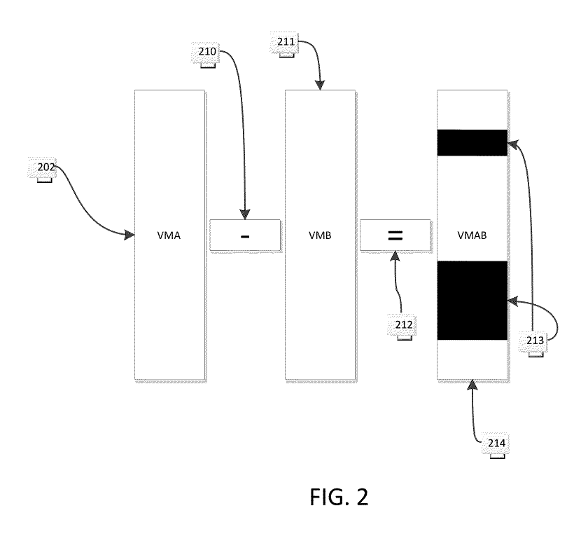

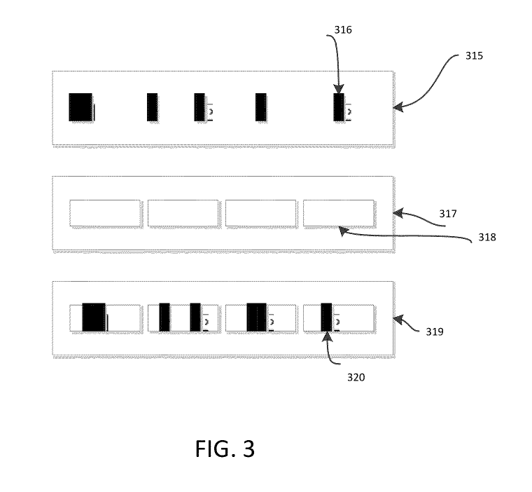

FIG. 2 discloses an embodiment with features 202, 210, 211, 212, 213, and 214. FIG. 3 refers to an embodiment where VMs 319 are assembled from fragments of data 315 and template VM images 317. The assembled VMs 319 are created by overwriting relevant sections of data 320 with fragments of data 315. Typically, the VMs 319 would be assembled by overwriting the relevant sections of their memory with data 315 loaded that is tagged with information about the appropriate memory position to place each fragment of data.

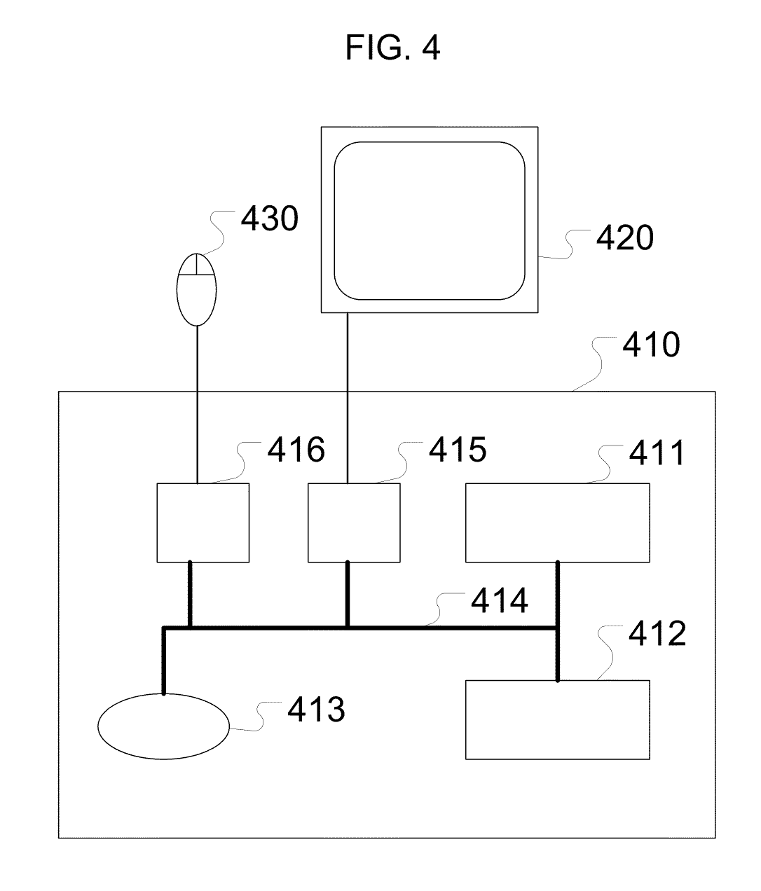

The embodiments described herein may be implemented with any suitable hardware and/or software configuration, including, for example, modules executed on computing devices such as computing device 410 of FIG. 4. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 410 has one or more processing device 411 designed to process instructions, for example computer readable instructions (i.e., code) stored on a storage device 413. By processing instructions, processing device 411 may perform the steps set forth in the methods described herein. Storage device 413 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 410 additionally has memory 412, an input controller 416, and an output controller 415. A bus 414 operatively couples components of computing device 410, including processor 411, memory 412, storage device 413, input controller 416, output controller 415, and any other devices (e.g., network controllers, sound controllers, etc.). Output controller 415 may be operatively coupled (e.g., via a wired or wireless connection) to a display device 420 (e.g., a monitor, television, mobile device screen, touch-display, etc.) In such a fashion that output controller 415 can transform the display on display device 420 (e.g., in response to modules executed). Input controller 416 may be operatively coupled (e.g., via a wired or wireless connection) to input device 430 (e.g., mouse, keyboard, touch-pad, scroll-ball, touch-display, etc.) In such a fashion that input can be received from a user (e.g., a user may input with an input device 430 a dig ticket).

Of course, FIG. 4 illustrates computing device 410, display device 420, and input device 430 as separate devices for ease of identification only. Computing device 410, display device 420, and input device 430 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 410 may be one or more servers, for example a farm of networked servers, a clustered server environment, or a cloud network of computing devices.

While systems and methods are described herein by way of example and embodiments, those skilled in the art recognize that disclosed systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method of optimizing the delivery and/or enablement of guest operating systems to distributed hypervisors, the method comprising:
pre-loading a virtual machine image;
overwriting the pre-loaded virtual machine image with fragments of data; and
streaming a display of the virtual machine to any connected device.

2. An apparatus for optimizing the delivery and/or enablement of guest operating systems to distributed hypervisors, the apparatus comprising:
one or more processors; and
one or more memories operatively coupled to at least one of the one or more processors and containing instructions that, when executed by at least one of the one or more processors, cause at least one of the one or more processors to:
pre-load a virtual machine image;
overwrite the pre-loaded virtual machine image with fragments of data; and
stream a display of the virtual machine to any connected device.

3. At least one non-transitory computer-readable medium storing computer-readable instructions that, when executed by one or more computing devices, optimize the delivery and/or enablement of guest operating systems to distributed hypervisors, the instructions causing at least one of the one or more computing devices to:
pre-load a virtual machine image;
overwrite the pre-loaded virtual machine image with fragments of data; and
stream a display of the virtual machine to any connected device.
